(19) United States
(12) Patent Application Publication
(10) Pub. No.: US 2019/0204945 A1
(43) Pub. Date: Jul. 4, 2019

(54) TOUCHSCREEN KEYBOARD ATTACHMENT FOR A PERSONAL COMPUTER

(71) Applicant: Seth Denny, Franklin, TN (US)

(72) Inventor: Seth Denny, Franklin, TN (US)

(21) Appl. No.: 16/231,460

(22) Filed: Dec. 22, 2018

Related U.S. Application Data
(60) Provisional application No. 62/612,261, filed on Dec. 29, 2017.

(51) Int. Cl. G06F 3/041; G06F 3/0354

(52) U.S. Cl. CPC G06F 3/041; G06F 3/03547

(57) ABSTRACT

The invention is directed to a touchscreen keyboard attachment for a personal computer. The attachment is small, easily carried, and comprises a rectangular touchscreen displaying a keyboard image, such that it may be easily grasped, carried, and plugged into a Universal Service Bus (USB) port on the user's personal computer, laptop, or other electronic device. The attachment provides data input to device in the same protocol as an external keyboard.

### RELATED APPLICATION(S

Under provisions of 35 U.S.C. § 119e, the Applicant(s) claim the benefit of U.S. provisional application No. 62/612,261 filed Dec. 29, 2017, which is incorporated herein by reference.

### FIELD OF THE INVENTION

The present invention relates generally to electronic devices and accessories, and in particular to a touchscreen keyboard attachment for a personal computer.

### BACKGROUND OF THE INVENTION

Online communications have grown and evolved remarkably over the past 40 years, and an entire generation has grown very proficient in the sending of text messages via a touchscreen keyboard on a smartphone or tablet. Unfortunately, millions of these users have not developed matching skills in typing on a conventional keyboard, therefore, they type much more slowly on conventional keyboards.

A search of the prior art reveals various devices which have been developed to address this set of problems, or related problems. None are closely related to the present invention, but several include features which resemble those of the present invention. Each has proven to be less than satisfactory for the present purpose in its own way.

Further, U.S. Patent Appl. No. 2010/0238119A1 (priority Mar. 18, 2009) titled “Touchscreen keyboard overlay” provides an external cover for a tablet smartphone with a flat touchscreen, which includes a rear clamshell formed of deformable plastic material that receives and surrounds the tablet, and a rim that resiliently clips the rear clamshell to the tablet. A hinge blister and intervening web forms a two degree of freedom hinge with a form-fitting front clamshell that can be freely lifted and dropped on the touchscreen but indexes to it, can be locked in place with a clip that readily engages and disengages from a docking port at the bottom of the tablet, and that is strengthened by an arch shaped rim. A planar sheet, formed of dielectric plastic, that covers the entirety of the flat touchscreen, is slightly suspended above to create an air gap, and is formed in a shape and thickness that substantially transmits the shape of a capacitive finger contact patch through the planar sheet to the touchscreen when the sheet is pushed down to the touchscreen. A keyboard may be formed in, on, or with the planar sheet in a location corresponding to the location of a virtual keyboard appearing on the touchscreen. However, the disclosed keyboard may not help users type efficiently while using personal computers.

Further, U.S. Patent Appl. No. 2013/0176228A1 (priority Nov. 10, 2011) titled “Touchscreen keyboard predictive display and generation of a set of characters” provides a communication device which includes a display with a layout including key locations with associated characters. The communication device detects an input gesture and determines one or more committed characters based at least in part on a change in the input gesture. The device presents one or more strings on the layout in association with key locations that are selected based at least in part on a relationship between each presented string and non-committed characters of each presented string. However, the disclosed keyboard may not help users type efficiently while using personal computers.

Further, U.S. Patent Appl. No. 2013/0093702A1 (priority Mar. 18, 2010), titled “Actionable-object controller and data-entry attachment for touchscreen-based electronics” provides a touchscreen-controller and data-entry ensemble which are attached conterminously or proximately to a touchscreen device. A touchscreen-controller attachment device has one or more input ends and one or more output ends. The input and output ends may be opposite ends of unitary elements and/or may be remote from one another and connected by wire or wirelessly. Each input end of a unitary conductive element is connected to a respective output end and the plurality of output ends, residing in an attachment base, are in a position of contact with or in close proximity to the soft buttons, keys or controller(s) of a touchscreen. The output ends thus activate the touchscreen when the input ends are manipulated. A base maintains the input and/or output ends in fixed position during use. Input and output elements can be spring-mounted. New controllers offer the user haptic ability. However, the disclosed data-entry attachment may not help users type efficiently while using personal computers.

Further, U.S. Patent Appl. No. 2011/0181514A1 (priority Dec. 14, 2009) titled “Touch keypad for touch screen devices” provides a touch keypad having a thin flexible body which is substantially transparent and which provides a keyboard feel, and which can overlie a display portion of a touchscreen device. The touch keypad a nonwoven or woven plastic material which is thin and provides raised portions to provide a tactile feel, the raised portions corresponding to specific keys of a touchscreen display. Alternatively, the device may instead include a flexible thin material, including thin woven or non-woven material, other than plastic. Such thin materials could include a thin glass material, extremely thin transparent steel with stamped or molded raised or depressed portions, or can include a paper material which is thin and provides raised portions to provide a tactile feel, the raised portions corresponding to specific keys of a touchscreen display. However, the disclosed keypad may not help users type efficiently while using personal computers.

Accordingly, there is a need for an improved which enables the user to apply touchscreen typing skills in a conventional keyboard setting that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Accordingly, the present disclosure provides a touchscreen keyboard attachment for a personal computer in accordance with some embodiments. The attachment is small, easily carried, arid comprises a rectangular touchscreen displaying a keyboard image, such that it may be easily grasped, carried, and plugged into a Universal Service Bus (USB) port on the user's personal computer, laptop, or other electronic device. The attachment provides data input to the device in the same protocol as an external conventional keyboard. Further, the touchscreen keyboard attachment includes a visual display, a touchpad, and a data cord.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top view of a touchscreen keyboard attachment for a personal computer, in accordance with a first exemplary embodiment.

FIG. 2 is a side perspective view of the touchscreen keyboard attachment of FIG. 1.

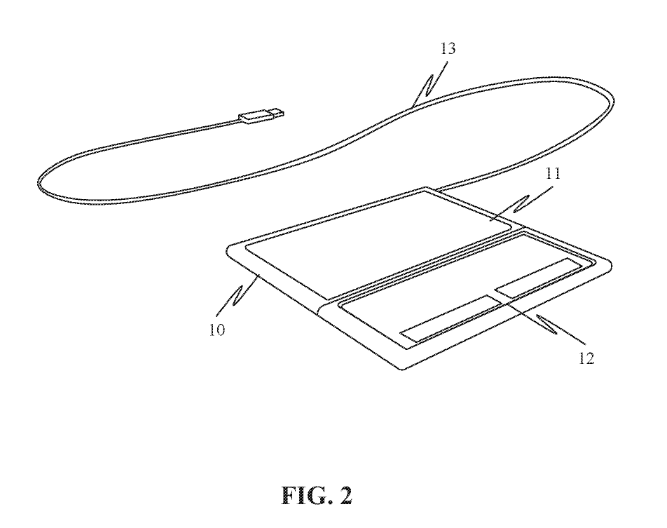

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a pluralit of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by e embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of input devices for personal computers, embodiments of the present disclosure are not limited to use only in this context.

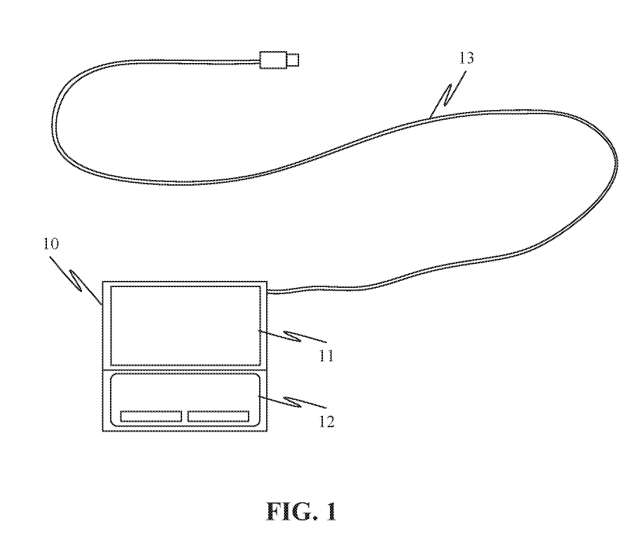

FIG. 1 is a top view of a touchscreen keyboard attachment 10 for a personal computer, in accordance with a first exemplary embodiment. The touchscreen keyboard attachment 10 includes a visual display 11, a touchpad 12, and a data cord 13.

It is to be understood that while the invention is intended for use to enable touchscreen data entry on a conventional personal computer or laptop, this is not intended as a limiting factor. With appropriate modifications or with no modifications at all, the invention could be used to enable such data entry on other devices,

According to some embodiments, the touchscreen keyboard attachment 10 is a small, portable, and provided in an extremely low-profile, gently contoured rectangular design with the touchscreen visual display 11 and the touchpad 12 on the top surface. The touchscreen keyboard attachment 10 may have a software installation that displays a keyboard image on the visual display 11, such that it may be used as a touchscreen keyboard, similar to those used on smartphones and tablets. The touchpad 12 is operated in the same manner as the touchpads found on many laptops. The software may also encode keystrokes on the touchscreen keyboard, and fingertip motion on the touchpad 12, and provides data input to device in the same protocol as an external conventional keyboard.

The touchscreen keyboard attachment 10 draws electric power from the personal computer, laptop, or other electronic device to which it is attached. Preferably, electronic components of the touchscreen keyboard attachment 10 include a microprocessor and a memory device.

The touchscreen keyboard attachment 10 is essentially a no call cell phone. The touchscreen keyboard is intended for those users who do not type at a reasonable speed on a conventional QWERTY keyboard. It is designed for typing on a computer as if the user were texting. The software may provide additional features such as a spell check function.

A user may plug the data cord 13 into the USB port of a personal computer, laptop, or other electronic device. The user may then operate the touchscreen keyboard and touchpad 12 of the touchscreen keyboard attachment 10 in the same manner as corresponding features on a smartphone and laptop.

The touchscreen keyboard attachment 10, the visual display 11, and the touchpad 12 are preferably manufactured from rigid, durable materials, such as steel, aluminum alloy, brass, ceramics, copper alloy, and plastic.

The visual display 11 may use at least one of Electroluminescent (EL) display, Liquid crystal (LC) display with Light-emitting diode (LED)-backlit Liquid crystal (LC) display, Light-emitting diode (LED) display, Organic Light-Emitting Diode (OLED) display, Active-Matrix Organic Light-Emitting Diode (AMOLED) display, Plasma (P) display, and Quantum dot (QD).

The touchpad 12 may use at least one of capacitive sensing and resistive sensing.

The data cord 13 is preferably manufactured from braided copper alloy wire sheathed in flexible plastic, and is preferably six feet in length. Longer and shorter lengths are also contemplated. Components, component sizes, and materials listed above are preferable, but artisans will recognize that alternate components and materials could be selected without altering the scope of the invention.

Although the invention has been explained in relation to its preferred embodiment, it is to be understood that many other possible modifications and variations can be made without departing from the spirit and scope of the invention.

What is claimed is:

1. A touchscreen keyboard attachment for a personal computer which is small, easily carried, and provided in an extremely low-profile, gently contoured rectangular design with a touchscreen visual display and a touchpad on the top surface, further comprised of factory installed software which displays a keyboard image on the visual display, such that it may be used as a touchscreen keyboard, similar to those used on smartphones and tablets.

2. The attachment of claim 1, wherein the keypad is operated in the same manner as the keypads found on many laptops.

3. The attachment of claim 1, wherein the software encodes keystrokes on the touchscreen keyboard, and fingertip motion on the touchpad, and provides data input to device in the same protocol as an external keyboard.

4. The attachment of claim 1, wherein the attachment draws electric power from the personal computer, laptop, or other electronic device to which it is attached.

5. The attachment of claim 1, wherein the electronic components of the attachment include microprocessor and a memory device.

6. The attachment of claim 1, wherein the user may plug the data cord into the USB port of a personal computer, laptop, or other electronic device. The user may then operate the touchscreen keyboard and touchpad of the attachment in the same manner as corresponding features on a smartphone and laptop.

7. The attachment of claim 1, wherein the attachment, the visual display, and the touchpad are preferably manufactured from rigid, durable materials, such as steel, aluminum alloy, brass, ceramics, copper alloy, and plastic.

8. The attachment of claim 1, wherein the data cord is preferably manufactured from braided copper alloy wire sheathed in flexible plastic, and is preferably six feet in length.
